(19) United States
(12) Patent Application Publication
(10) Pub. No.: US 2018/0126506 A1
(43) Pub. Date: May 10, 2018

(54) MACHINE TOOL

(71) Applicant: FANUC CORPORATION, Yamanashi (JP)

(72) Inventor: Tetsushi TAKAHARA, Yamanashi (JP)

(21) Appl. No.: 15/808,112

(22) Filed: Nov. 9, 2017

(30) Foreign Application Priority Data
Nov. 10, 2016 (JP) 2016-219777

(51) Int. Cl. B23Q 11/00; B23Q 11/10

(52) U.S. Cl. CPC B23Q 11/0067; B23Q 11/0046; B23Q 11/1069; B23Q 11/10; B23Q 11/0064

(57) ABSTRACT

A machine tool includes a spindle to which a tool is attached, and a table configured to support a workpiece, and machines the workpiece by the tool by moving the spindle and the table relative to each other. The machine tool includes a box-shaped cover member placed on the table and configured to be open on the spindle side, and a lid member attached to a column configured to support the spindle, the lid member being configured to cover the spindle side of the cover member, the lid member including an insertion hole formed therein through which the tool can be inserted. Following the relative movement between the spindle and the table, the lid member and the cover member move relative to each other as viewed in a plane intersecting with the axial direction of the spindle.

### CROSS-REFERENCE TO RELATED APPLICATION

This application is based upon and claims the benefit of priority from Japanese Patent Application No. 2016-219777 filed on Nov. 10, 2016, the contents of which are incorporated herein by reference.

### BACKGROUND OF THE INVENTION

### Field of the Invention

The present invention relates to a machine tool for machining a workpiece with a tool.

### Description of the Related Art

Powdery chips are often produced during machining with a machine tool. When dry machining is performed without taking any measures against such chips, the chips scatter and infiltrate into mechanical units such as a driving mechanism etc., for driving a table that supports a workpiece to be machined. This may cause deterioration of the mechanical units or damage components of the mechanical units undesirably. On the other hand, in the case of wet machining using cutting fluid, flying and scattering of chips can be suppressed as compared with the dry machining, but the possibility of infiltration of chips into mechanical units is higher than in the case of dry machining.

Japanese Laid-Open Utility Model Publication No. 02-004738 discloses a chip blocking device for a machine tool that prevents flying and scattering of chips. Briefly explaining, a box-shaped cover formed with a tool passage hole and a chip dropping hole is configured to cover a workpiece supported on a table while a cup-shaped cover is attached to the spindle end to which a tool is attached, whereby scattering of chips to the surroundings is blocked by the box-shaped cover and cup-shaped cover.

### SUMMARY OF THE INVENTION

However, in the above-mentioned Japanese Laid-Open Utility Model Publication No. 02-004738, since the tool passes through the tool passage hole formed in the box-shaped cover to machine the workpiece, it is impossible to machine the workpiece when the tool and the workpiece relatively move on a plane.

It is therefore an object of the present invention to provide a machine tool capable of preventing chips from entering mechanical units while allowing a relative movement between a tool and a workpiece on a plane with a simple structure.

According to one aspect of the present invention, there is provided a machine tool equipped with a spindle to which a tool is attached and a table configured to support a workpiece, the spindle and the table being moved relative to each other so as to machine the workpiece by the tool, the machine tool including: a box-shaped cover member placed on the table and configured to be open at a side thereof closer to the spindle; and a lid member attached to a support member configured to support the spindle, the lid member being configured to cover the side of the cover member closer to the spindle, the lid member including an insertion hole formed therein through which the tool can be inserted, wherein following relative movement between the spindle and the table, the lid member and the cover member move relative to each other as viewed in a plane intersecting with an axial direction of the spindle.

Thus, provision of the above simple configuration makes it possible to prevent the chips produced during machining from scattering out of the space that is enclosed by the cover member and the lid member while enabling the relative movement between the tool and the workpiece in the plane. Therefore, it is possible to prevent chips from entering multiple mechanical units such as the drive mechanisms for driving the tool and the table. In addition, it becomes unnecessary to provide a cover for preventing infiltration of chips into each of the multiple mechanical units, thereby reducing the cost.

In the above machine tool of the present invention, the cover member may include a discharge port configured to discharge chips produced during the machining of the workpiece by the tool. With this, the chips present in the space formed by the cover member and the lid member can be discharged so as to prevent the chips from accumulating on the bottom wall of the cover member.

In the above machine tool of the present invention, the discharge port may be formed in a bottom wall of the cover member on which the workpiece is placed. This facilitates discharge of chips from the discharge port.

The above machine tool of the present invention may further include a suction device configured to suction chips produced during machining, through the discharge port. With this configuration, it is possible to suitably discharge the chips in the space defined by the cover member and the lid member, through the discharge port.

The machine tool of the present invention may further include a cutting fluid supply device configured to supply a cutting fluid to the tool located inside the cover member, and the cutting fluid supply device may be configured to collect the cutting fluid containing chips produced during machining, through the discharge port. This configuration enables preferable discharge of chips through the discharge port while the cutting fluid containing chips can be collected. Further, since the cutting fluid is supplied to the tool, it is possible to suppress scattering of chips.

In the above machine tool of the present invention, the cutting fluid supply device may be configured to filtrate the collected cutting fluid and supply the filtrated cutting fluid to the tool again. Thereby, the cutting fluid can be circulated so that it is possible to reduce consumption of the cutting fluid.

The above machine tool of the present invention may further include an attracting part provided inside the cover member and configured to attract chips produced during machining, by magnetic force or electrostatic force. This configuration can suppress scattering of chips.

The above machine tool of the present invention may further include a sealing member provided between the cover member and the lid member. Thereby, it is possible to prevent chips from scattering to outside through the gap between the cover member and the lid member.

In the above machine tool of the present invention, the lid member may include an openable/closable door or a lid configured to exchange the workpiece placed inside the cover member. This configuration facilitates exchange of workpieces.

In the above machine tool of the present invention, the lid member may be formed larger than the cover member as viewed in the plane intersecting with the axial direction of the spindle in a manner that the lid member covers an entire opening of the cover member from a side thereof closer to the spindle even when the lid member and the cover member are moved relative to each other. Thereby, even when the cover member and the lid member move relative to each other, the space formed by the cover member and the lid member can be isolated, so that it is possible to prevent chips from scattering outside of the space.

In the above machine tool of the present invention, the lid member may be attached to the support member so as to be urged toward the cover member. Thereby, it is possible to prevent chips from scattering outside through the gap between the cover member and the lid member.

According to the present invention, provision of the above simple configuration makes it possible to prevent the chips produced during machining from scattering out of the space that is enclosed by the cover member and the lid member while enabling the relative movement between the tool and the workpiece in the plane. Therefore, it is possible to prevent chips from infiltrating into multiple mechanical units such as the drive mechanisms for driving the tool and the table. In addition, it becomes unnecessary to provide a cover for preventing infiltration of chips into each of the multiple mechanical units, thereby reducing the cost.

The above and other objects features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is an overall configuration diagram of a machine tool according to a first embodiment of the present invention;

FIG. 2 is a schematic diagram showing a configuration for suppressing scattering of chips according to the first embodiment;

FIG. 3 is a diagram showing a state where a table is moved to a position for exchanging workpieces in FIG. 2; and

FIG. 4 is a schematic diagram showing a configuration for suppressing scattering of chips according to a second embodiment of the present invention.

### DESCRIPTION OF THE PREFERRED EMBODIMENTS

A machine tool according to the present invention will be detailed hereinbelow by describing preferred embodiments with reference to the accompanying drawings.

### First Embodiment

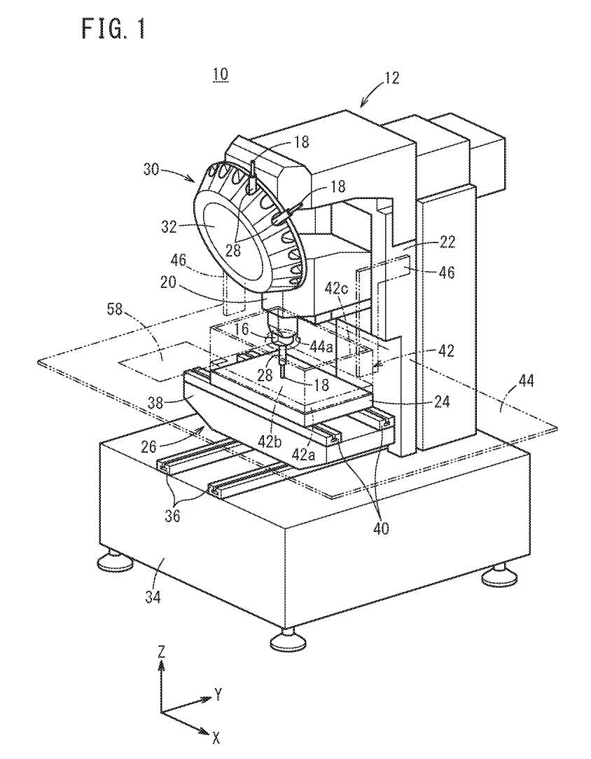

FIG. 1 is an overall configuration diagram of a machine tool 10. The machine tool 10 at least includes a main machine body 12.

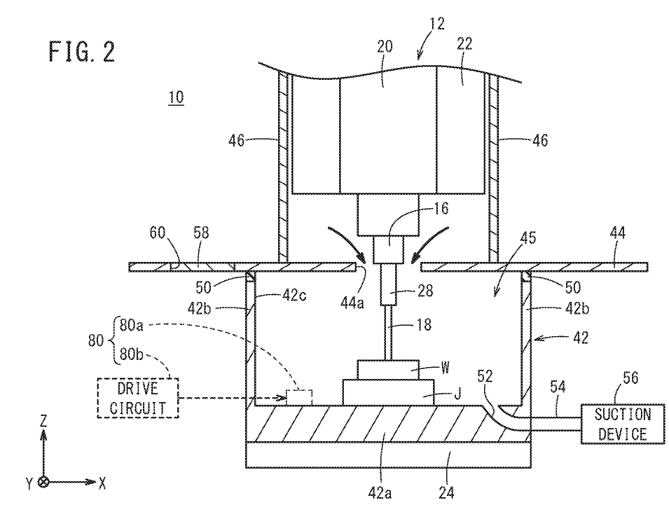

In the main machine body 12, a workpiece W (see FIG. 2) is machined by a tool (cutting tool) 18 attached to a spindle 16. The main machine body 12 includes a spindle 16, a spindle head 20 for rotationally driving the spindle 16 about a rotary axis parallel to the Z-direction, a column 22 for moving the spindle head 20 in the Z-direction (vertical direction), a table 24 arranged under the spindle 16 to support the workpiece W, and a table drive unit 26 for moving the table 24 in the X-direction and the Y-direction. It is assumed that the X-direction, the Y-direction and the Z-direction are ideally orthogonal to each other. Combination of the movement of the spindle 16 in the Z-direction and the movement of the table 24 in the X-direction and the Y-direction enables the machine tool 10 to machine the workpiece W in three dimensions. The gravity acts in the negative Z-direction.

The tool 18 is held by a tool holder 28. The tool holder 28 is attachable to and detachable from the spindle 16, and the tool 18 is attached to the spindle 16 via the tool holder 28. The tool holder 28 is inserted into a mounting hole (not shown) arranged at the distal end of the spindle 16, whereby the tool 18 is attached to the spindle 16. The tool 18 turns together with the spindle 16. The main machine body 12 is configured as a machining center in which the tool 18 to be attached to the spindle 16 can be changed by an automatic tool changer 30. The automatic tool changer 30 has a tool magazine 32 capable of accommodating (holding) multiple tools 18 each held by the tool holder 28. Examples of the tools 18 may include non-turning tools, drills, end mills, milling cutters, and others.

A Z-axis driving mechanism (not shown) for moving the spindle head 20 in the Z-axis direction relative to the column 22 is coupled to the spindle head 20. The Z-axis driving mechanism has a servomotor and a driving-power conversion mechanism (ball screw, nut, etc.) for converting rotational motion of the servomotor into linier motion and transmitting the motion to the spindle head 20. Further, the spindle 16 is rotated about the Z-axis by the driving of an unillustrated spindle motor installed in the spindle head 20.

The table drive unit 26 is supported by a base 34. The table drive unit 26 has a Y-axis slider 36, a saddle 38 and an X-axis slider 40. The saddle 38 is supported so as to be movable in the Y-direction with respect to the base 34 via the Y-axis slider 36. The table 24 is supported so as to be movable in the X-direction with respect to the saddle 38 via the X-axis slider 40.

An unillustrated Y-axis driving mechanism for moving the saddle 38 in the Y-direction relative to the base 34 is coupled with the saddle 38. Similarly, an unillustrated X-axis driving mechanism for moving the table 24 in the X-direction relative to the saddle 38 is coupled with the table 24. The Y-axis driving mechanism and the X-axis driving mechanism each have a servomotor and a driving-power conversion mechanism (ball screw, nut, etc.) for converting rotational motion of the servomotor into linear motion and transmitting the motion to the saddle 38 and the table 24, respectively. As the X-axis driving mechanism, the Y-axis driving mechanism, and the Z-axis driving mechanism, well-known ones can be used.

A box-shaped cover member 42 for covering the machining area to thereby prevent chips arising due to machining from scattering to the surroundings is placed on the table 24. The cover member 42 is fixed and supported on a top surface of the table 24. Therefore, the cover member 42 moves together with the table 24 in the X-direction and the Y-direction on the X-Y plane. The cover member 42 is formed of a bottom wall 42a placed on the table 24 and a side wall 42b extending upward from the bottom wall 42a and surrounding the machining area. Thus, the cover member 42 is open on the spindle 16 side or the positive Z-direction side (a side closer to the spindle). That is, the cover member 42 has an opening 42c formed on the positive Z-direction side.

A plate-shaped lid member 44 that covers the positive Z-direction side of the cover member 42, i.e., the opening 42c, is attached to the column (support member) 22 supporting the spindle 16 (spindle head 20). The lid member 44 is fixed to the column 22 by means of stays 46. This lid member 44 has an insertion hole 44a through which the tool 18 and the tool holder 28 can be inserted. The lid member 44 is formed larger than the cover member 42 in the X-Y plane view so as to cover the entire opening 42c even when the table 24 (the cover member 42) is moved along the X-Y plane.

Provision of the lid member 44 as above makes it possible to prevent the chips produced during machining from scattering from the upper side of the cover member 42 to the outside. That is, the chips generated during machining scatter inside a space (closed space) 45 (see FIG. 2) enclosed by the cover member 42 and the lid member 44. Since the chips scatter within the space 45 only, this configuration facilitates cleaning of the main machine body 12.

Though the lid member 44 is formed with the insertion hole 44a, only an extremely small amount of scattering chips leaks outside (out of the space 45) through the insertion hole 44a because the tool 18 and the tool holder 28 are inserted into the insertion hole 44a. Note that the lid member 44 may be attached to the column 22 via the stays 46 such that the lid member 44 is urged toward the cover member 42. For example, the stays 46 may support the lid member 44 via an urging mechanism (not shown) that urges the lid member 44 toward the cover member 42.

FIG. 2 is a schematic diagram showing a configuration for suppressing scattering of chips in the first embodiment. A sealing member 50 is provided between the cover member 42 and the lid member 44. The sealing member 50 is arranged at least between the brim of the cover member 42 and the lower surface of the lid member 44. FIG. 2 shows an example in which the sealing member 50 is arranged on the brim of the cover member 42 along the shape of the brim of the cover member 42. The sealing member 50 may also be provided on the entire surface of the lower surface of the lid member 44. Instead of the sealing member 50, a brush or the like may be provided along the brim of the cover member 42.

Since the cover member 42 is mounted on the top surface of the table 24, the workpiece W is fixed to the upper surface of the bottom wall 42a of the cover member 42 by means of a workpiece fixing jig J.

The cover member 42 is formed with a discharge port 52 for discharging chips produced during machining. The scattering chips fall down (in the negative Z-direction) with time due to gravity, and accumulate on the bottom wall 42a of the cover member 42. Accordingly, it is preferable to provide the discharge port 52 in the bottom wall 42a. At this time, the discharge port 52 is preferably arranged between the upper surface of the bottom wall 42a and the top surface of the table 24. With this configuration, since the discharge port 52 is positioned below the chips accumulating on the bottom wall 42a, chips can be easily discharged from the discharge port 52.

This discharge port 52 is connected to a suction device 56 through a discharge pipe 54 such as a duct hose (hose). The suction device 56 is a vacuum device (chip collecting vacuum device) for suctioning chips and gas (air). The chips flying in the space 45 and the chips accumulating on the bottom wall 42a can be suctioned from the discharge port 52 by the suction device 56, hence the chips existing in the space 45 are suitably discharged. Since the chips are discharged, the cover member 42, the lid member 44, the workpiece fixing jig J, etc., can be easily cleaned after machining.

In addition, since air suctioning of the suction device 56 draws the air over the lid member 44 into the space 45 through the insertion hole 44a of the lid member 44, it is possible to further suppress scattering of chips produced during machining through the insertion hole 44a to the outside of the space 45.

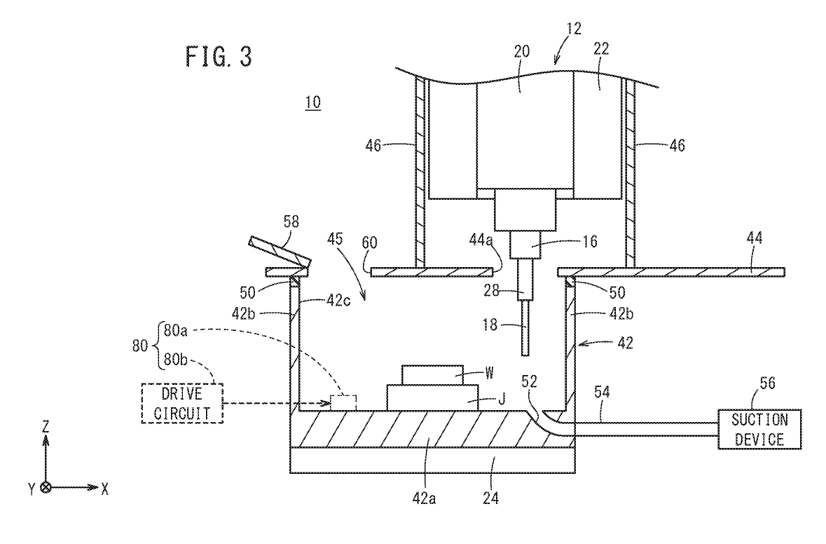

The lid member 44 has an openable/closable door 58 (see also FIG. 1) for allowing exchange of the workpiece W placed inside the cover member 42. The door 58 covers an opening 60 formed in the lid member 44 for exchange of workpieces W. As shown in FIG. 3, as the door 58 is opened after the table 24 has been moved to the position for exchange, the workpiece W (or the workpiece fixing jig J) and the bottom wall 42a are exposed through the opening 60 of the lid member 44 and the opening 42c of the cover member 42. When the table 24 is moved to the position for exchange, at least the opening 42c of the cover member 42 and the opening 60 overlap each other in the X-Y plane view.

As a result, it is possible to take out the machined object (workpiece) W through the opening 60 or set an unprocessed workpiece W inside the cover member 42 (to the workpiece fixing jig J) from the opening 60. Though the door 58 illustrated in FIG. 3 is a hinged door that swings on unillustrated hinges, the door 58 may be a sliding door or a sliding and swinging door. Instead of the door 58, a lid capable of opening and closing the opening 60 may be used.

### Second Embodiment

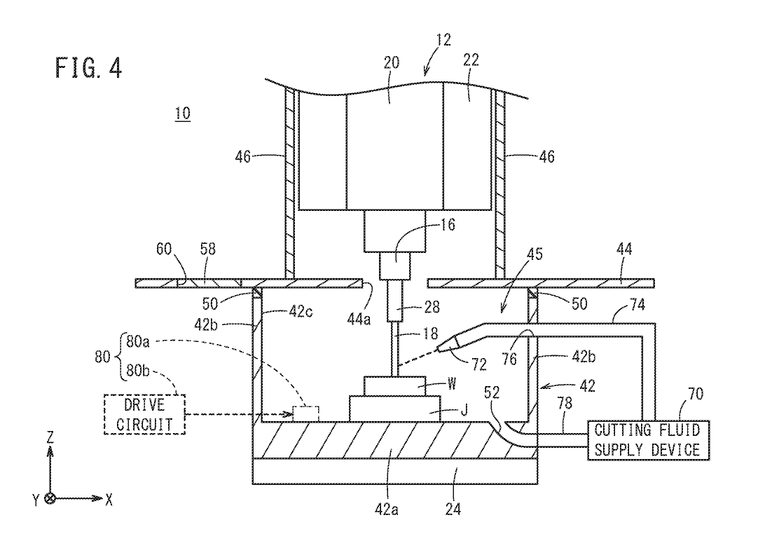

FIG. 4 is a schematic diagram showing a configuration for suppressing scattering of chips according to the second embodiment. Here, it should be noted that the same constituents and constructional elements as those in the first embodiment will be denoted by the same reference numerals, and description thereof is omitted.

Though the first embodiment was described by giving a case of a dry type machining process, the second embodiment will be described by taking an example of a wet type machining process. In the second embodiment, instead of the suction device 56 the machine tool 10 includes a cutting fluid supply device 70 to supply cutting fluid to the tool 18 located in the interior (space 45) of the cover member 42.

The cutting fluid supply device 70 and a nozzle 72 in the space 45 are connected to each other via a supply pipe 74 such as a hose. The cutting fluid supply device 70 supplies the cutting fluid to the nozzle 72 via the supply pipe 74. The nozzle 72 ejects the supplied cutting fluid toward the tool 18. Thus, the cutting fluid is supplied to the tool 18. The supplied cutting fluid mixes with chips, flows down to the bottom wall 42a of the cover member 42, and then stands in the cover member 42. Since the chips produced during machining are mixed with the cutting fluid, scattering of chips is suppressed. The cover member 42 (side wall 42b) is provided with an insertion hole 76 through which the supply pipe 74 is inserted with a sealing member (not shown) provided between the insertion hole 76 and the supply pipe 74. It should be noted that the insertion hole 76 for insertion of the supply pipe 74 may be formed in the bottom wall 42a or in the lid member 44. Alternatively, instead of forming the insertion hole 76, the supply pipe 74 may be passed through the insertion hole 44a of the lid member 44.

The discharge port 52 is connected to the cutting fluid supply device 70 via a drain pipe 78 such as a drain hose (hose). The cutting fluid supply device 70 collects the cutting fluid containing the chips that has been discharged from the discharge port 52. It should be noted that the cutting fluid supply device 70 may collect the cutting fluid by suctioning the cutting fluid with chips. The cutting fluid supply device 70 filtrates the cutting fluid containing the collected chips to thereby remove the chips present in the cutting fluid. The cutting fluid thus filtrated is free from chips. The cutting fluid supply device 70 supplies the thus-filtered cutting fluid to the nozzle 72 once again.

In the above way, supplying the cutting fluid causes the cutting chips to mix with the cutting fluid so that the cutting fluid with the cutting chips can be collected from the discharge port 52. Accordingly, the cover member 42, the lid member 44, the workpiece fixing jig J, and others can be easily cleaned after completion of the machining. Further, the cutting chips can be discharged suitably from the discharge port 52 while the cutting fluid can be collected. Moreover, since the cutting fluid can be circulated, it is possible to save the cutting fluid.

### [Modifications]

The above-described embodiments can also be modified as follows.

### (Modification 1)

In the first embodiment, an example of dry machining has been described, but wet machining may be performed. In this case, a supply device for supplying cutting fluid to the tool 18 is additionally provided, and the suction device 56 suctions the cutting fluid containing chips from the discharge port 52.

### (Modification 2)

The machine tool 10 of each of the above embodiments may include an attracting device 80 shown by the dotted line in FIG. 2 and FIG. 4. This attracting device 80 generates a force (magnetic force, electrostatic force or the like) to attract chips. The attracting device 80 is composed of an attracting part 80a for attracting chips by magnetic force, electrostatic force or the like, and a drive circuit 80b. The drive circuit 80b drives the attracting part 80a so as to produce magnetic force, electrostatic force or the like. Owing to provision of the attracting part 80a inside the cover member 42, the chips in the space 45 are attracted to the attracting part 80a, so that scattering of chips can be suppressed.

### (Modification 3)

In each of the above embodiments, the table 24 is moved along the X-Y plane. However, it is possible to provide a configuration in which the spindle 16 (the spindle head 20) is moved along the X-Y plane. That is, the spindle 16 (the spindle head 20) may be moved in the X-direction and the Y-direction. In this case, the lid member 44 also moves together with the spindle 16 (spindle head 20). This can be done, for example, by configuring the column 22 so as to be movable in the X-direction and the Y-direction.

### (Modification 4)

The above Modifications 1 to 3 may be arbitrarily combined as long as no technical inconsistency occurs.

As above, the machine tool 10 described in the embodiments and Modifications 1 and 2, includes a spindle 16 to which a tool 18 is attached and a table 24 for supporting a workpiece W, and is configured such that the spindle 16 and the table 24 are moved relative to each other so as to machine the workpiece W by the tool 18. The machine tool 10 includes: a box-shaped cover member 42 placed on the table 24 and configured to be open on the spindle 16 side, and a lid member 44, formed with an insertion hole 44a through which the tool 18 can be inserted, and attached to a column (support member) 22 supporting the spindle 16 so as to cover the spindle 16 side of the cover member 42. Following the relative movement between the spindle 16 and the table 24, the lid member 44 and the cover member 42 move relative to each other as viewed in a plane (X-Y plane) intersecting with the axial direction of the spindle 16 (the direction of the rotary axis, Z-direction).

Thus, provision of the above simple configuration makes it possible to prevent the chips produced during machining from scattering out of the space 45 that is enclosed by the cover member 42 and the lid member 44 while enabling the relative movement between the tool 18 and the workpiece W as viewed in the X-Y plane. Therefore, it is possible to prevent chips from entering multiple mechanical units such as the column 22, the Y-axis slider 36, the X-axis slider 40, the Z-axis drive mechanism, the Y-axis drive mechanism and the X-axis drive mechanism. In addition, it becomes unnecessary to provide a cover for preventing entrance of chips on each of the multiple mechanical units, thereby reducing the cost.

The cover member 42 may have a discharge port 52 formed therein to discharge chips produced during the machining of the workpiece W by the tool 18. With this, the chips present in the space 45 formed by the cover member 42 and the lid member 44 can be discharged so as to prevent the chips from accumulating on the bottom wall 42a of the cover member 42. The discharge port 52 is preferably formed in the bottom wall 42a of the cover member 42 on which the workpiece W is placed. This makes it easy to discharge the chips from the discharge port 52.

The machine tool 10 may further include a suction device 56 to suction the chips through the discharge port 52. This configuration makes it possible for the chips in the space 45 to be discharged through the discharge port 52 suitably.

The machine tool 10 may further include a cutting fluid supply device 70 to supply a cutting fluid to the tool 18 located inside the cover member 42, and the cutting fluid supply device 70 may be configured to collect the cutting fluid containing chips through the discharge port 52. With this configuration, it is possible to suitably discharge chips through the discharge port 52 while the cutting fluid containing chips can be collected. Further, since the cutting fluid is supplied to the tool 18, it is possible to suppress scattering of chips.

The cutting fluid supply device 70 may be configured to filtrate the collected cutting fluid and supply the filtrated cutting fluid to the tool 18 again. Thereby, the cutting fluid can be circulated so that it is possible to reduce consumption of the cutting fluid.

The machine tool 10 may further include an attracting part 80a provided inside the cover member 42 to attract chips by magnetic force, electrostatic force, or the like. This configuration can suppress scattering of chips.

The machine tool 10 may further include a sealing member 50 provided between the cover member 42 and the lid member 44. Thereby, it is possible to prevent chips from scattering to the outside through the gap between the cover member 42 and the lid member 44.

The lid member 44 may include an openable/closable door 58 or a lid for exchanging the workpiece W set inside the cover member 42. This configuration facilitates exchange of workpieces W.

The lid member 44 may be formed larger than the cover member 42 as viewed in a plane (X-Y plane) intersecting with the direction of the axis of the spindle 16 (Z-direction) in a manner that the lid member 44 can cover the entire opening 42c of the cover member 42 from the spindle 16 side even when the lid member 44 and the cover member 42 are moved relative to each other. Thereby, even when the cover member 42 and the lid member 44 move relative to each other, the space 45 formed by the cover member 42 and the lid member 44 can be isolated, so that it is possible to prevent chips from scattering outside of the space 45.

The lid member 44 may be attached to the column 22 so as to be urged toward the cover member 42. Thereby, it is possible to prevent chips from scattering to the outside through the gap between the cover member 42 and the lid member 44.

While the invention has been particularly shown and described with reference to preferred embodiments, it will be understood that variations and modifications can be effected thereto by those skilled in the art without departing from the scope of the invention as defined by the appended claims.

What is claimed is:

1. A machine tool equipped with a spindle to which a tool is attached and a table configured to support a workpiece, the spindle and the table being moved relative to each other so as to machine the workpiece by the tool, comprising:
a box-shaped cover member placed on the table and configured to be open at a side thereof closer to the spindle; and
a lid member attached to a support member configured to support the spindle, the lid member being configured to cover the side of the cover member closer to the spindle, the lid member including an insertion hole formed therein through which the tool can be inserted,
wherein, following relative movement between the spindle and the table, the lid member and the cover member move relative to each other as viewed in a plane intersecting with an axial direction of the spindle.

2. The machine tool according to claim 1, wherein the cover member includes a discharge port configured to discharge chips produced during machining of the workpiece by the tool.

3. The machine tool according to claim 2, wherein the discharge port is formed in a bottom wall of the cover member on which the workpiece is placed.

4. The machine tool according to claim 2, further comprising a suction device configured to suction chips produced during machining, through the discharge port.

5. The machine tool according to claim 2, further comprising a cutting fluid supply device configured to supply a cutting fluid to the tool located inside the cover member, wherein the cutting fluid supply device is configured to collect the cutting fluid containing chips produced during machining, through the discharge port.

6. The machine tool according to claim 5, wherein the cutting fluid supply device is configured to filtrate the collected cutting fluid and supply the filtrated cutting fluid to the tool again.

7. The machine tool according to claim 1, further comprising an attracting part provided inside the cover member and configured to attract chips produced during machining, by magnetic force or electrostatic force.

8. The machine tool according to claim 1, further comprising a sealing member provided between the cover member and the lid member.

9. The machine tool according to claim 1, wherein the lid member includes an openable/closable door or a lid configured to exchange the workpiece placed inside the cover member.

10. The machine tool according to claim 1, wherein the lid member is formed larger than the cover member as viewed in the plane intersecting with the axial direction of the spindle in a manner that the lid member covers an entire opening of the cover member from a side thereof closer to the spindle even when the lid member and the cover member are moved relative to each other.

11. The machine tool according to claim 1, wherein the lid member is attached to the support member so as to be urged toward the cover member.
